(19) United States
(12) Patent Application Publication
(10) Pub. No.: US 2010/0313762 A1
(43) Pub. Date: Dec. 16, 2010

(54) System For Generating A Useful Gas Enriched In A Given Component

(75) Inventors: Dirk Roeck, Ingersheim (DE); Torsten Grundmann, Besigheim (DE); Juergen Schmidt, Boennigheim (DE)

Correspondence Address: FACTOR & LAKE, LTD, 1327 W. WASHINGTON BLVD., SUITE 5G/H, CHICAGO, IL, 60607, US

(73) Assignee: DUERR TECHNIK GMBH & CO. KG., Bietigheim-Bissingen (DE)

(21) Appl. No.: 12/377,411

(22) PCT Filed: Jul. 31, 2007
(86) PCT No.: PCT/EP07/06740

§ 371 Date: May 13, 2009

(30) Foreign Application Priority Data
Aug. 16, 2006 (DE) 10 2006 038 439.3

(51) Int. Cl. B01D 53/02; B01D 53/08; B01D 53/30

(52) U.S. Cl. 96/111; 96/108; 96/113; 96/150

(57) ABSTRACT

A system for obtaining oxygen-enriched air from ambient air comprises an absorber moving bed separating unit whose adsorption material binds oxygen and nitrogen to a different degree. To flush out moisture remaining in the moving bed material, it is proposed to connect a useful gas store which comprises the oxygen-enriched air to the inlet of the separating unit at time intervals via a controllable flush valve, and to flush the moisture out of the moving bed material in the useful gas store by means of dry gas. This shortens the start phase which elapses after switching on until steady-state conditions are established.

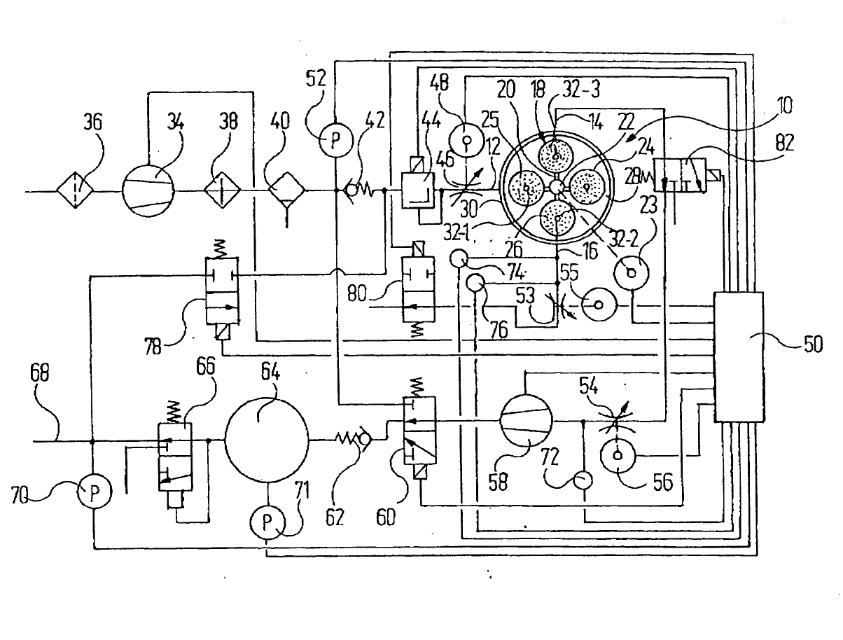

### RELATED APPLICATIONS

This application claims the filing benefit of International Patent Application No. PCT/EP2007/006740, filed Jul. 31, 2007, which claims the filing benefit of German Patent Application No. 10 2006 038 439.3 filed Aug. 16, 2006, the contents of which are incorporated herein by reference.

### TECHNICAL FIELD

The invention relates to a system for generating a useful gas enriched with a given component including a plurality of different components. The system comprising a separation unit, which comprises an absorber material which has different adsorption behaviour for the predetermined component and the other components of the gas mixture; a compressor for supplying the gas mixture to the separation unit under pressure; and, a second compressor for conveying the useful gas which is enriched with the specific component into a useful gas storage device, wherein the outlet of the useful gas storage device can be connected to the inlet of the separation unit by means of a controllable flushing valve.

### BACKGROUND OF THE INVENTION

Systems of this type are known in particular for producing air which is enriched with oxygen. The separation units which they contain may comprise, on the one hand, membranes which have differing degrees of permeability with respect to oxygen and nitrogen. However, they may also comprise beds of absorber material which bonds with oxygen and nitrogen to differing degrees.

In general, one of the components of the initial gas mixture may accumulate over time in the separation unit and impair the operating capacity thereof. In the case of the production of air which is enriched with oxygen, these are in particular moisture components which remain on the absorber material and consequently impair the separation between useful gas and residual gas.

The invention is directed to resolving these and other matters.

### SUMMARY OF THE INVENTION

An object of the present invention is therefore to develop a system for generating a useful gas enriched with a given component in such a manner that the accumulation of harmful components in the separation unit is counteracted.

This object may be achieved according to the invention with a system comprising a separation unit, which comprises an absorber material which has different adsorption behaviour for the predetermined component and the other components of the gas mixture; a compressor for supplying the gas mixture to the separation unit under pressure; and, a second compressor for conveying the useful gas which is enriched with the specific component into a useful gas storage device, wherein the outlet of the useful gas storage device can be connected to the inlet of the separation unit by means of a controllable flushing valve.

In the system according to the invention, in order to discharge the harmful component or plurality of harmful components from the separation unit, it is possible to return a portion of the dry useful gas contained in the gas storage container to the inlet of the separation unit again. The dry useful gas then flushes out the harmful components which have remained in the separation unit, whereby the original good separating capacity of the separation unit is restored again.

By this means, it is also possible for the start phase to be shortened which, after a start-up operation, continues until the separation unit has reached the desired enrichment level or separation level.

In one aspect of the present invention, damage to the separation unit owing to application of excessively high pressure is prevented by utilization of the controllable flushing valve connected to the outlet of the useful gas storage device by means of a pressure limitation device.

In another aspect of the present invention, utilization of a controllable throttle facilitates controlling the gas mixture flow into the separation unit and drawing off the residual gas flow and the useful gas flow from the separation unit. It is possible to adjust these gas flows in each case in such a manner that the adsorption dynamics and desorption dynamics of the absorber material with respect to useful gas and residual gas are taken into account.

In yet another aspect of the present invention, utilization of a variety of concentration measurement devices facilitates the determination of the quality of the current operation of the separation unit to be measured via the measured concentrations of useful gas and residual gas at the corresponding outlets of the separation unit. From the output signals of the corresponding concentration measurement devices, a superior control system can derive whether the current method parameters should be modified or whether a regeneration phase must be introduced.

In a still further aspect of the present invention, utilization of the separation unit including a moving bed arrangement that contains the absorber material provides for useful gas to be produced almost continuously.

In yet a still further aspect of the present invention, it is possible to automatically adjust the time for the adsorption and desorption to a favourable value by utilizing a drive—which moves the moving bed arrangement—controlled in accordance with the output of a concentration meter.

In an additional aspect of the present invention, utilization of at least one controllable throttle—which controls one of the gas flows entering/discharging from the separation unit—operates in accordance with the output signal of at least one concentration meter that cooperates with one of the gas flows discharged from the separation unit provides for the incoming gas mixture and the outgoing useful gas or residual gas to be adjusted in accordance with at least a measured concentration so that it is also possible in this manner to maintain the composition of the useful gas constant substantially regardless of the current state of the separation unit.

In another additional aspect of the present invention, the enrichment level is automatically kept constant through control of the controllable flushing valve in accordance with the output signal of at least one concentration meter that cooperates with one of the gas flows discharged from the separation unit.

In yet a further additional aspect of the present invention, utilization of a controllable pressure regulator at the inlet of the separation unit provides for the pressure of the gas mixture introduced into the separation unit to be adjusted in a simple manner in accordance with the respective requirements.

In still a further additional aspect of the present invention, proximate the inlet of the controllable pressure regulator there is connected a pressure sensor whose output signal is used by a control unit to control the operation of the compressor that provides the pressurized gas mixture, thus enabling the pressure adjustment to be carried out in a particularly economical manner since the compressor already builds up as much pressure as is required.

In yet another additional aspect of the present invention, the control unit additionally controls the compressor that provides the gas mixture in accordance with the output signal of a concentration meter that is arrange downstream of one of the outlets of the separation unit. As such, the pressure which the gas mixture compressor builds up can be automatically adapted to the respective operating behaviour of the separation unit as can be seen from the output signal of a concentration measuring device.

If an enrichment system is reactivated after a relatively long idle period, the full separating capacity of the separation unit is not achieved initially. In yet a further additional aspect of the present invention, the compressor that urges useful gas into the useful gas storage device can be connected to the inlet of the separation unit by means of a controllable return valve; therefore making it is possible to allow the quantities of useful gas obtained in the start-up phase to flow through the separation unit again and thus to improve the pre-separation already achieved to obtain a separation with the desired proportion of useful gas.

And in yet a still further additional aspect of the present invention, controlling the return valve in accordance with the output signal of a concentration meter that is connected to one of the outlets of the separation unit provides for the control system of the start-up valve to be controlled automatically in accordance with the quality of the useful gas obtained or the residual gas obtained in each case. These qualities both allow the current operating behaviour of the separation unit to be determined.

It is to be understood that the aspects and objects of the present invention described above may be combinable and that other advantages and aspects of the present invention will become apparent upon reading the following description of the drawings and

### BRIEF DESCRIPTION OF THE DRAWING

The sole FIGURE is a block diagram of the fluidic and electrical components of a system for producing oxygen enriched air from ambient air.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

The system illustrated in the drawing for producing air enriched with oxygen comprises as a core a separation unit which is generally designated 10 and which has an inlet 12 for pressurised ambient air, a first outlet 14 for oxygen-enriched air (useful gas) and a second outlet 16 for nitrogen-enriched air (residual gas).

In the embodiment considered in this instance, the separation unit 10 comprises four separation columns 18 which are carried by a shaft 22 via radial arms 20. The shaft 22 is driven by means of an electric motor 23, preferably a step motor.

The separation columns 18 each comprise a cylindrical metal housing 24, in which a bed 25 of absorber material is located. This absorber material may, for example, be a silicate material. The ends of the housings 24 are closed by means of gas-permeable sintered metal plates 26.

The housings 24 move with the sintered metal plates 26 thereof in a gas-tight manner between end faces 28 of a cylindrical housing 30. The end faces 28 have, at predetermined locations, openings 32-1, 32-2 and 32-3, which are connected to the inlet 12, the first outlet 14 and the second outlet 16, respectively, as illustrated in the FIGURE.

For the purposes of explanation, it will be assumed that the bed 25 of absorber material bonds with oxygen to a greater extent than nitrogen.

If the absorber material bed 25 of a separation column 18 has been filled with pressurised ambient air, when it is located at the opening 32-1, and if the separation column arrangement is then rotated through 90° in a counter-clockwise direction as far as the opening 32-2, if the separation column arrangement is left in this position for a predetermined length of time, nitrogen is first released from the bed 25 since it cooperates to a lesser extent with the absorber material.

If the separation columns 18 are now rotated in two following periods of time to such an extent that the separation column 18 in question has now reached the opening 32-3, the gas remaining in the separation column now has the opportunity to flow away out of the bed 25. However, this gas contains more oxygen since oxygen bonds to a greater extent with the absorber material.

The supply of ambient air to the separation unit 10 and the removal of oxygen-enriched air and nitrogen-enriched air from the separation unit 10 will be described in greater detail below. Further below, there will then be described how moisture components which bond strongly with the absorber material and which have a disadvantageous effect on the operation thereof in the long term are removed from the separation unit.

The supply of pressurised ambient air to the separation unit 10 is provided by a compressor 34 which draws from the environment via an air filter 36. The air which is discharged from the compressor and which is heated during compression is supplied to the inlet 12 of the separation unit 10 via a heat-exchanger 38, a condensate separator 40, a non-return valve 42 and a controllable pressure regulator 44 and a controllable throttle 46.

The controllable throttle 46 is adjusted by means of a motor 48 which is actuated from a control unit 50 which is illustrated only schematically.

The pressure which is built-up by the compressor 34 is measured by a pressure sensor 52 which is connected to the control unit 50.

In order to adjust the control pressure, the adjustable pressure regulator 44 comprises an electromagnet which is also supplied from the control unit 50.

The useful gas outlet 14 of the separation unit 10 is connected to the inlet of a second compressor 58 by means of a controllable throttle 54 which is adjusted by an electric motor 56, preferably a step motor. The electric motor 56 is also actuated by means of the control unit 50.

In a similar manner, the discharge of residual gas from the outlet 16 is influenced by means of a controllable throttle 53 which is adjusted by means of an electric motor 55. This is again excited by means of the control unit 50.

The compressor 58 is connected to a useful gas storage device 64 by means of a 3/2-way solenoid valve 60 and a non-return valve 62.

The useful gas storage device is connected to a discharge pipe 68 for oxygen-enriched air by means of a pressure regulator 66 which is illustrated as a three/two-way valve with pneumatic control. The pressure on the discharge pipe 68 is measured by means of a pressure sensor 70 which is also connected to the control unit 50. An additional pressure sensor 71 measures the pressure in the useful gas storage device 64. The output signals of the pressure sensors 70 and 71 are transmitted to inputs of the control unit 50.

The 3/2-way solenoid valve 60 is used, in a start-up phase of the system, in which the separation level of the separation unit 10 is still reduced, to return the air which is discharged from the compressor 58 and which is already enriched but not yet sufficiently enriched, to the inlet of the separation unit 10 via the non-return valve 42, the pressure regulator 44 and the controllable throttle 46. When these pre-enriched air components are reprocessed and, together with the part-quantities of air provided by the compressor 34, reach the separation unit 10, the desired level of oxygen enrichment is ultimately achieved.

In order to constantly monitor the oxygen content of the enriched air, there is connected to the pipe which leads to the compressor 58 an oxygen concentration meter 72 whose output signal is transmitted to the control unit 50. The output signal of the concentration meter 72 is consequently a measure for the quality of the operation of the separation unit.

For security, it is also possible to additionally measure the nitrogen content at the outlet 16 by means of a nitrogen concentration meter 74 which is also connected to the control unit 50. In addition, it is also possible to measure the water vapour content of the residual gas by means of a water vapour concentration meter 76 which is connected to the outlet 16. If the output signal of the concentration meter 76 exceeds a specific threshold value, it is apparent that the absorber material has absorbed an excessive amount of moisture and should be regenerated.

After switching on, the system illustrated in the drawing thus operates in such a manner that the 3/2-way solenoid valve is redirected from the rest position adjusted by means of resilient pretensioning until the concentration meter 72 indicates that the desired oxygen content of the enriched air is achieved. The output signal of the concentration meter 72 can be combined with that of the concentration meter 74 since both signals extend in the same direction.

If the power supply to the solenoid valve 60 is ended after the desired concentration of oxygen has been reached, the compressor 58 conveys air which is now enriched with oxygen into the useful gas storage device 64. As soon as the pressure in the useful gas storage device 64 exceeds the value predetermined by the pressure regulator 66, oxygen-enriched air can be tapped at the discharge pipe 68. The application of oxygen-enriched air to the discharge pipe 68 can be monitored by means of the output signal of the pressure sensor 70.

If only a small amount of oxygen-enriched air is tapped from the discharge pipe 68, the pressure which the pressure sensor 52 measures increases and the control system 50 can then accordingly reduce the excitement of the drive motor of the compressor 34 or completely switch it off. Accordingly, it is possible to control the excitement of the compressor 58.

If the pressure sensor 71 which is connected to the useful gas storage device 64 determines that the pressure in the useful gas storage device 64 has dropped below a predetermined threshold, the control unit 50 ensures that the two compressors 34, 58 resume their normal operation.

If the control unit 50 determines, with reference to one or more of the output signals of the concentration meters 72, 74, 76, that a regeneration of the separation unit 10 is required, the control unit 50 switches the solenoid valve 78 from the rest position illustrated in the drawing into the operating position and dry oxygen-enriched air is directed via the pressure regulator 44 and the controllable throttle 46 to the inlet 12 of the separation unit 10. This dry air absorbs moisture components which have accumulated in the beds 25 of the separation columns 18 and carries them from the separation unit 10.

In order to be able to select the period of time for which gas can flow away through the outlet 16, regardless of the rotation speed of the arrangement of separation columns 18 and regardless of the flow time through the outlet 14, the flow from the outlet 16 can be completely stopped by means of a normally open 3/2-way valve 80 in a manner controlled by the control unit 50.

On the one hand, for the same reason, a 3/2-way solenoid valve 82 is connected to the outlet 14 and is also actuated by the control unit 50.

In order to further discharge from the system the moisture-enriched air which is also discharged at the outlet 16 during regeneration, the 3/2-way solenoid valve 82 is moved from the rest position connecting the outlet 16 to the compressor 58 into an operating position in which the outlet 16 is connected to the surrounding atmosphere. This adjustment of the solenoid valve 82 is also carried out via the control unit 50.

If it can be seen from the output signals of one or more of the concentration meters 72 to 76 that the beds 24 of the separation columns 18 are operating normally again, the regeneration mode is ended and the 3/2-way solenoid valve 78 is returned to the blocking rest position.

The control of the 3/2-way solenoid valves 78, 80 and 82 is carried out by means of the control unit 50 on a time basis in accordance with experimental values and/or in accordance with the output signals of the oxygen concentration meter 72 and/or the nitrogen concentration meter 74 and/or the moisture concentration meter 76.

With the system described above, it is possible to produce in an almost stable manner oxygen-enriched air which has on average a consistent level of oxygen enrichment. This is achieved by moisture being intermittently removed from the absorber material beds 25 using dry, oxygen-enriched useful gas which is returned from the useful gas storage device 64 via the 3/2-way solenoid valve 78 to the inlet of the pressure regulator 44.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1. A system for producing a useful gas enriched with a specific component from a gas mixture which comprises a plurality of different components, the system comprising: a separation unit having an absorber material which has different adsorption behavior for the predetermined component and the other components of the gas mixture; a compressor for supplying the gas mixture to the separation unit under pressure; and a second compressor for conveying the useful gas which is enriched with the specific component into a useful gas storage device, wherein the outlet of the useful gas storage device can be connected to the inlet of the separation unit by means of a controllable flushing valve.

2. The system of claim 1, wherein the controllable flushing valve is connected to the outlet of the useful gas storage device by means of a pressure limitation device.

3. The system of claim 1, wherein a controllable throttle is arranged upstream of the inlet of the separation unit.

4. The system of claim 1, wherein a controllable throttle is arranged downstream of the useful gas outlet and/or the residual gas outlet of the separation unit.

5. The system of claim 1, wherein, downstream of the useful gas outlet of the separation unit, there is arranged a concentration meter which responds to the predetermined component.

6. The system of claim 1, wherein, downstream of the residual gas outlet of the separation unit, there is arranged a concentration meter which responds to at least one of the residual gas components.

7. The system of claim 6, wherein, downstream of the residual gas outlet, there is provided a concentration meter which responds to moisture.

8. The system of claim 1, wherein the separation unit has a moving bed arrangement which contains the absorber material.

9. The system of claim 5, wherein a drive which moves the moving bed arrangement is controlled in accordance with the output signal of a concentration meter.

10. The system of claim 3, wherein at least one controllable throttle, which controls one of the gas flows discharged from the separation unit or the gas flow entering the separation unit, operates in accordance with the output signal of at least one concentration meter which cooperates with one of the gas flows discharged from the separation unit.

11. The system of claim 1, wherein the controllable flushing valve is controlled in accordance with the output signal of at least one concentration meter which cooperates with one of the gas flows discharged from the separation unit.

12. The system of claim 1, wherein a controllable pressure regulator is provided at the inlet of the separation unit.

13. The system of claim 12, wherein at the inlet of the controllable pressure regulator, there is connected a pressure sensor whose output signal is used by a control unit to control the operation of the compressor which provides the pressurized gas mixture.

14. The system of claim 13, wherein the control unit additionally controls the compressor which provides the gas mixture in accordance with the output signal of a concentration meter which is arranged downstream of one of the outlets of the separation unit.

15. The system of claim 1, wherein the compressor, which urges useful gas into the useful gas storage device, can be connected to the inlet of the separation unit by means of a controllable return valve.

16. The system of claim 5, wherein the return valve is controlled in accordance with the output signal of a concentration meter which is connected to one of the outlets of the separation unit.

17. The system of claim 2, wherein a controllable throttle is arranged upstream of the inlet of the separation unit.

18. The system of claim 2, wherein a controllable throttle is arranged downstream of the useful gas outlet and/or the residual gas outlet of the separation unit.

19. The system of claim 3, wherein a controllable throttle is arranged downstream of the useful gas outlet and/or the residual gas outlet of the separation unit.

20. The system of claim 2, wherein downstream of the useful gas outlet of the separation unit, there is arranged a concentration meter which responds to the predetermined component.
